(19) United States
(12) Patent Application Publication
(10) Pub. No.: US 2019/0111670 A1
(43) Pub. Date: Apr. 18, 2019

(54) METHOD FOR MANUFACTURING OPTICAL DISPLAY DEVICE

(71) Applicant: NITTO DENKO CORPORATION, Ibaraki-shi, Osaka (JP)

(72) Inventors: Teruaki OSAWA, Ibaraki-shi (JP); Daigo SUZUKI, Ibaraki-shi (JP); Masatake USUI, Ibaraki-shi (JP); Hiroyuki ABE, Ibaraki-shi (JP); Takuya NAKAZONO, Ibaraki-shi (JP); Kazuo KITADA, Ibaraki-shi (JP)

(21) Appl. No.: 16/088,775

(22) PCT Filed: Mar. 16, 2017
(86) PCT No.: PCT/JP2017/010611

§ 371 Date: Sep. 26, 2018

(30) Foreign Application Priority Data
Apr. 6, 2016 (JP) 2016-076285

(51) Int. Cl. B32B 37/12; B32B 37/00; B29C 65/00; B29C 65/48

(52) U.S. Cl. CPC B32B 37/12; B29C 65/48; B29C 66/83413; B32B 37/187

(57) ABSTRACT

Method for manufacturing an optical display device which allows for appropriately correcting a linear deformation generated on a pressure-sensitive adhesive layer in laminating an optical functional film with a panel member includes steps of peeling a sheet of optical functional film together with the pressure-sensitive adhesive layer from a carrier film up to a predetermined head-out length, stopping the conveyance of the carrier film for detecting the front edge, making the front edge of the sheet of optical functional film proceed to the laminating position, laminating from the front edge to a predetermined position upstream of the head-out length on the sheet of optical functional film with the panel member at a first lamination speed, and laminating at least a part from the predetermined position to a rear edge of the sheet of optical functional film with the panel member at a speed faster than the first lamination speed.

### TECHNICAL FIELD

The present invention relates to a method for manufacturing an optical display device. In particular, the present invention relates to a method for manufacturing an optical display device which allows for eliminating a linear deformation generated on a pressure-sensitive adhesive layer at a time of detecting a front edge of a sheet of optical functional film peeled from a carrier film by decreasing initial speed in laminating a sheet of optical functional film with a rectangular panel.

### BACKGROUND ART

In recent years, in a manufacturing scene of optical display devices, a manufacturing apparatus and a method of Roll-to-Panel (RTP) are employed (for example, Patent Document 1). In the RTP method, generally, an optical display device is manufactured as follows. First, a band of optical film laminate having a predetermined width is fed from a roll. The band of optical film laminate is configured as including a band of carrier film, a pressure-sensitive adhesive layer formed on one of opposite surfaces of the carrier film, and an optical film supported on the carrier film via the pressure-sensitive adhesive layer. The optical film may be a single-layered or multi-layered film. On the band of optical film laminate fed from the roll, slit lines are continuously formed in a width-wise direction to form sheets of optical functional film between adjacent slit lines.

Among the sheets of optical functional film continuously supported on the carrier film, generally, the sheets which do not have defect or defects are peeled with the pressure-sensitive adhesive layer from the carrier film by a peeling means arranged near a laminating position, and fed to the laminating position. Each of the sheets of optical functional film reached to the laminating position is laminated with a face to be laminated of a corresponding panel member separately conveyed to the laminating position by a laminating means having a pair of upper and lower lamination rollers.

At the peeling means having a tip end facing the laminating position, a carrier film side of the optical film laminate is covered on the tip end of the substantially wedge-shaped peeling means. The sheet of optical functional film is peeled together with the pressure-sensitive adhesive layer from the carrier film as the carrier film covered on the peeling means is folded over and conveyed to a direction substantially opposite to a conveying direction of the sheet of optical functional film being conveyed toward the laminating position. In the present specification, a position of the apparatus where the sheet of optical functional film is peeled from the carrier film is referred as a peeling position, and the peeling position exists near the tip end of the peeling means.

In such RTP system, the sheet of optical functional film on the carrier film may be fed to the laminating position with the panel member, with its posture deviated from the ideal one. In this case, it is necessary to laminate the panel member with the sheet of optical functional film after correcting (also referred as “aligning”) the posture of the panel member depending on a deviation condition of the sheet of optical functional film. In order to determine the posture of the sheet of optical functional film required for this correction, a front edge of the sheet of optical functional film before lamination is detected by taking an image thereof using an imaging means such as an optical camera, for example. In detecting the front edge, it is preferable to detect it when a front part, in the conveying direction, of the sheet of optical functional film is peeled from the carrier film and the front edge is between the peeling position and the laminating position (for example, Patent Document 2). In the present specification, a length of the sheet of optical functional film peeled from the carrier film for detecting the front edge is referred as a head-out length.

### CITATION LIST

Patent Document 1: Japanese Patent 4377964B
Patent Document 2: Japanese Patent 5458212B

### SUMMARY OF INVENTION

### Technical Problem

In the apparatus having a configuration in which the front edge of the sheet of optical functional film is detected when the front edge is at a detecting position between the peeling position and the laminating position, the sheet of optical functional film is peeled by the head-out length, and when the front edge reaches the detecting position, the conveyance of the carrier film is stopped. At this point, the pressure-sensitive adhesive layer is peeled together with the sheet of optical functional film from the carrier film, from the front edge to a position corresponding to the head-out length, and from such position to a rear edge, it is in a state still laminated to the carrier film.

When the conveyance is stopped in such head-out state, a linear deformation is generated on a surface of the carrier film side of the pressure-sensitive adhesive layer at a part corresponding to the peeling position when being stopped. FIG. 1 (a) and FIG. 1 (b) shows the linear deformation which is generated on the pressure-sensitive adhesive layer. As shown in FIG. 1 (a), the deformation of the pressure-sensitive adhesive layer is formed at the front part in the conveying direction of the sheet of optical functional film along the front edge, extending in a width-wise direction with a height. FIG. 1(b) shows a result of a part of the linear deformation generated on the pressure-sensitive adhesive layer observed by a microscope. If a sheet of optical functional film having a pressure-sensitive adhesive layer with such linear deformation generated thereon is laminated with a panel member, a deformation of the sheet of optical functional film due to the deformed pressure-sensitive adhesive layer and/or entrapment of bubbles between the panel member and the pressure sensitive adhesive layer may be generated, and these may be a cause of defect or defects of an image display device.

FIG. 2(a) and FIG. 2(b) respectively shows an example of a configuration of an optical film laminate F used in the present invention. As shown in FIG. 2(a) and FIG. 2(b), a thickness of a pressure-sensitive adhesive layer F2 on a carrier film F3 side which is to be laminated later with a rectangular panel (a layer shown as a first pressure-sensitive adhesive layer in the figure) is generally about 25 μm. On the other hand, a thickness of a relatively thick optical functional film (a first protection film, a polarizer, a second protection film, a second pressure-sensitive adhesive layer and a surface protection film) F1 as in FIG. 2(a) is about 255 μm, and thus, a thickness of the pressure-sensitive adhesive layer F2 is only about one-tenth of the optical functional film F1. In a case of such thick optical functional film, even if linear defect or defects is/are generated on the pressure-sensitive adhesive layer, such defect or defects was/were not recognized as a deformation to the extent what would become defect or defects on an image of the optical display device. However, as the optical functional films are becoming thinner, and a thin optical functional film having a thickness of 110 μm, for example, as shown in FIG. 2(b) appears, a ratio of the thickness of the pressure-sensitive adhesive layer F2 to the thickness of the optical functional film F1 becomes larger compared with a case of the prior thick optical functional film. Along with the spread of such thin optical functional film, the linear deformation formed on the pressure-sensitive adhesive layer is becoming what cannot be left untouched since it may be defect or defects on the image of the optical display device.

The present invention aims to provide a method for manufacturing an optical display device which allows for appropriately correcting a linear deformation generated on a pressure-sensitive adhesive layer when laminating an optical functional film with a panel member without sacrificing time necessary for laminating a sheet of the optical functional film with the panel member as the best one can.

### Solution to Problem

In order to solve the above problem, the present invention provides, in one aspect thereof, a method for manufacturing an optical display device from a band of optical film laminate including a carrier film, a pressure-sensitive adhesive layer formed on one of opposite surfaces of the carrier film and a plurality of sheets of optical functional film continuously supported on the carrier film via the pressure-sensitive adhesive layers by peeling the sheet of optical functional film together with the pressure-sensitive adhesive layer from the carrier film of the band of optical film laminate, and laminating the peeled sheet of optical functional film with a corresponding one of panel members at a laminating position.

The method comprises steps of peeling the sheet of optical functional film together with the pressure-sensitive adhesive layer from the carrier film by conveying the carrier film, with the carrier film being folded over at a tip end of a peeling body arranged at a position facing the laminating position, and when the sheet of optical functional film is peeled by a predetermined head-out length from a front edge, stopping conveyance of the carrier film for detecting the front edge. When the conveyance of the carrier film is stopped for detecting the front edge, that is, when the sheet of optical functional film is stopped in a head-out state, the linear deformation as shown in FIG. 1(a) and FIG. 1 (b) is generated on a surface of a carrier film side of the pressure-sensitive adhesive layer at a part corresponding to the peeling position when being stopped.

The present invention further comprises steps of, after the detection of the front edge, conveying the carrier film for making the front edge of the sheet of optical functional film proceed to the laminating position, and laminating the sheet of optical functional film with the panel member.

The step of laminating the sheet of optical functional film with the panel member comprises laminating from the front edge to a predetermined position upstream of the head-out length on the sheet of optical functional film with the panel member at a first lamination speed being as the maximum speed, and laminating at least a part from the predetermined position to a rear edge of the sheet of optical functional film with the panel member at a second lamination speed faster than the first lamination speed. The linear deformation generated on the pressure-sensitive adhesive layer in the step of detecting the front edge may be appropriately corrected by laminating the sheet of optical functional film with the panel member up to the predetermined position which is a position on the upstream side of where the deformation exists at the first speed slower than the second speed. The phrase, the linear deformation is “appropriately corrected” in the present specification refers not only a state where the linear deformation of the pressure-sensitive adhesive layer is completely corrected (a state where a height of the deformation is zero), but also a state where the deformation is corrected to an extent that it may not be recognized as defect or defects on an image of the optical display device in an inspection of a post-process.

According to one embodiment of the present invention, it is preferable that the predetermined position is a position spaced for 50 mm to 200 mm from the front edge of the sheet of optical functional film, the first lamination speed is 2 mm/second to 100 mm/second, and waiting time from when the conveyance of the carrier film for detecting the front edge is stopped to when the conveyance of the carrier film is restarted after detection is 3 seconds to 5 seconds.

### BRIEF DESCRIPTION OF DRAWINGS

FIG. 1(a) and FIG. 1 (b) shows a linear deformation generated on a pressure-sensitive adhesive layer, wherein FIG. 1(a) is a diagram showing a position of the linear deformation generated on a surface of a carrier film side of the pressure-sensitive adhesive layer, and FIG. 1 (b) is a microscope photograph of a part of the linear deformation.

FIG. 2(a) and FIG. 2 (b) shows an example of an optical film laminate used in the present invention, wherein FIG. 2(a) is a configuration of the optical film laminate which has been used conventionally, and FIG. 2(b) is a configuration of a thin optical film laminate.

FIG. 3 is a conceptual diagram of an entire configuration of a continuous manufacturing apparatus 1 for continuously manufacturing an optical display device according to one embodiment of the present invention.

FIG. 4 (a), FIG. 4 (b), FIG. 4 (c) and FIG. 4 (d) is a diagram showing operations of, at a laminating part, peeling a sheet of optical functional film, detecting a front edge, and laminating the sheet of optical functional film with a panel member.

FIG. 5 is a diagram showing a change of speed in laminating a sheet of optical functional film with a panel member.

FIG. 6 is a diagram showing a relationship of a speed in laminating a sheet of optical functional film with a panel member, and a height of linear deformation after lamination.

FIG. 7 is a table showing Examples and Comparative Examples of the present invention.

### DESCRIPTION OF EMBODIMENTS

In the following, embodiments of the present invention are described in detail with reference to the drawings. The present invention is not limited to these embodiments.

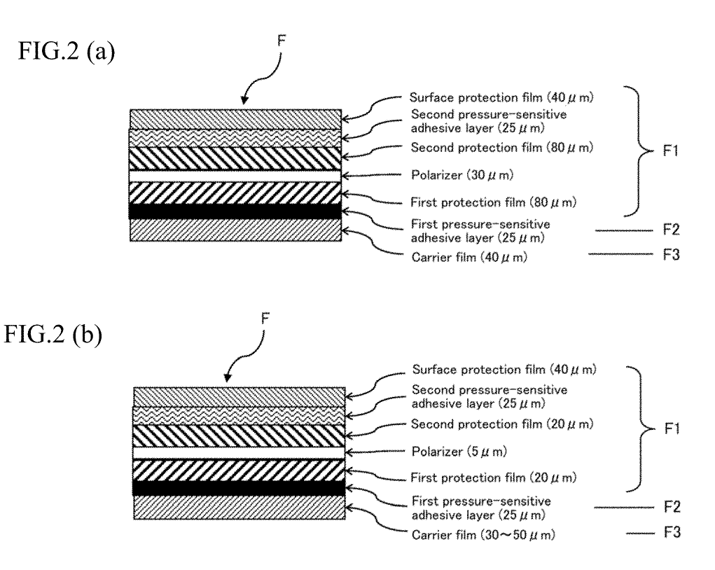

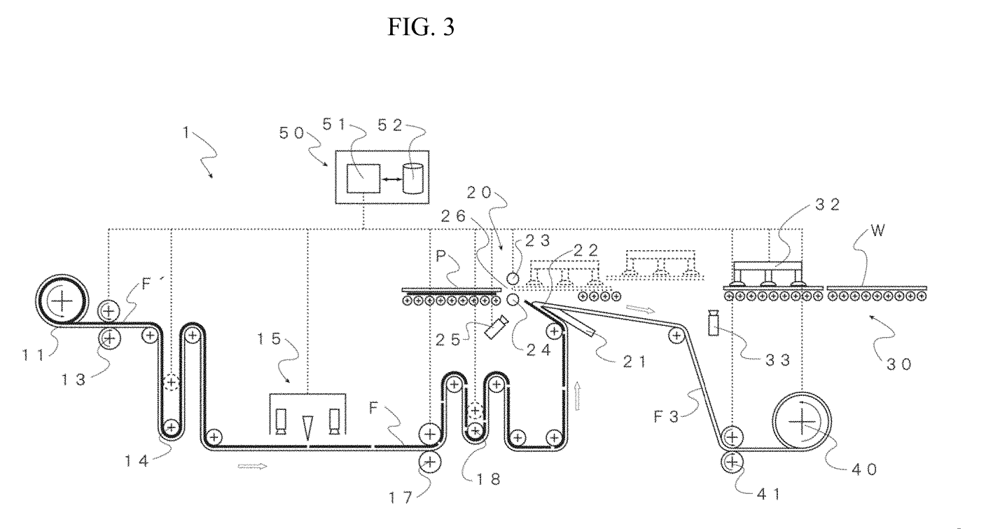

FIG. 3 is a conceptual diagram of an entire configuration of an apparatus 1 for continuously manufacturing an optical display device according to one embodiment of the present invention. In the continuous manufacturing apparatus 1, an optical film laminate F having a configuration shown, for example, in FIG. 2 (a) and FIG. 2 (b) may be used. The optical film laminate F is made by continuously laminating a plurality of sheets of optical functional film F in a length-wise direction on a band of a carrier film F3 via a pressure-sensitive adhesive layer F2. In the continuous manufacturing apparatus 1, an optical display device may be continuously manufactured by peeling a sheet of optical functional film F1 together with the pressure-sensitive adhesive layer F2 from the band of carrier film F3, and laminating the peeled sheet of optical functional film F1 with a panel member W using a pair of lamination rollers 23, 24. Operations of each of the parts of the continuous manufacturing apparatus 1 may be controlled by a controlling means 51 of a controller 50, and data etc. used in each of the parts are stored in a storing means 52 and is used as needed. In the present invention, the sheet of optical function film F1 may comprise any of a polarizing film, an antireflection film, a phase difference film, an optical diffusion film, a brightness enhancement film and surface protection film or combination thereof, and the panel member W may be a liquid crystal panel, an organic electroluminescence panel etc.

The continuous manufacturing device 1 operates as in the followings. First, a band of optical film laminate F′ is fed from a roll 11. The optical film laminate F′ is made by laminating the band of optical functional film F′ on the band of a carrier film F3 via the pressure-sensitive adhesive layer F2. Then, slit lines CL which depth reaches to the pressure-sensitive adhesive layer F2 are formed on the optical film laminate F′ in a width-wise direction of the optical film laminate F′ at a slitting part 15 comprising a cutter provided on the way in a conveyance channel (this operation is also referred as “half-cut”). The optical film laminate F is thus made by forming slit lines CL on the optical film laminate F′. In another embodiment, an optical film laminate with preliminarily formed slit lines CL may also be used. In this case, the slitting part 15 is unnecessary.

The optical film laminate F is fed to a laminating part 20 via feed rollers 13 and 17 which feed films, dancing rollers 14 and 18 which adjust feeding speed of the films, a removing part (not shown) which removes sheets of optical film laminate having defect or defects etc. as needed.

On the other hand, the panel member W, which is an adherend to which the sheet of optical functional film F1 is laminated, is fed one by one from a magazine (not shown), where a plurality of panel members W, for example, are contained, and conveyed by a conveying means 30 such as a roller conveyer, for example. Posture of the panel member W is detected by a panel position detecting means 33 at an aligning part 32, and after the posture is corrected (aligned) depending on a deviation condition of the sheet of optical functional film F1, the panel member W is fed to the laminating part 20.

At the laminating part 20, the sheet of optical functional film F1 is peeled together with the pressure-sensitive adhesive layer F2 from the carrier film F3 by a peeling means 21. The peeled sheet of optical functional film F1 is laminated with the panel member W by lamination rollers 23 and 24. The carrier film F3, after the sheet of optical functional film F1 and the pressure-sensitive adhesive layer F2 are peeled therefrom, is wound by a winding means 40. A panel laminate P, in which the sheet of optical functional film F1 is laminated with the panel member W, is carried out from the laminating part 20 by the conveying means 30.

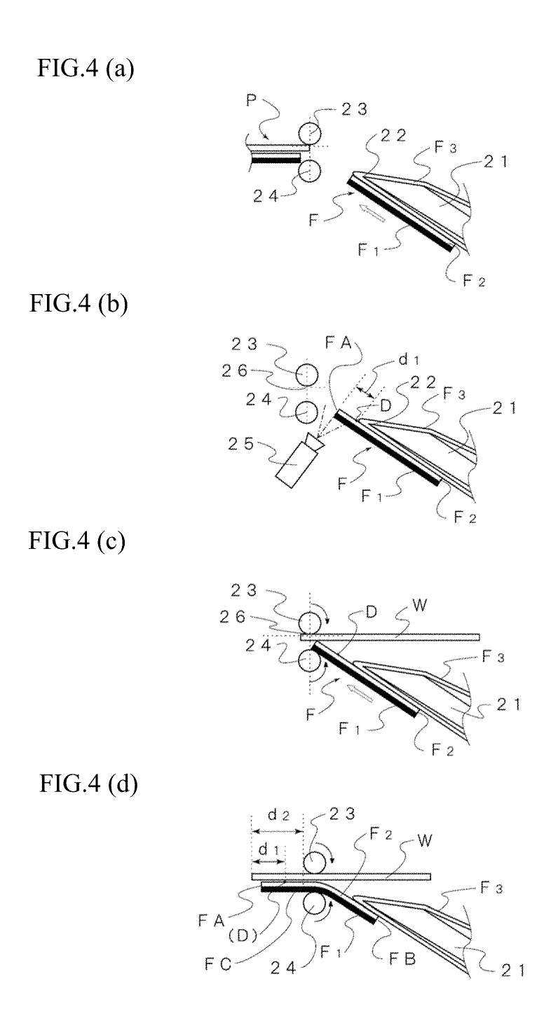

Next, operations at the laminating part 20 are described with reference to FIG. 4(a), FIG. 4 (b), FIG. 4 (c) and FIG. 4 (d). In FIG. 4 (a), FIG. 4(b), FIG. 4 (c) and FIG. 4(d), processes are shown to proceed in the order from FIG. 4 (a) to FIG. 4 (d). At the laminating part 20, the sheet of optical functional film F1 is peeled, the front edge of the sheet of optical functional film F1 is detected, and the sheet of optical functional film F1 and the panel member W are laminated.

The laminating part 20 comprises, as shown in FIGS. 3 and 4, the peeling means 21 for peeling the sheet of optical functional film F1 together with the pressure-sensitive adhesive layer F2 from the band of carrier film F3, the front edge detecting means 25 for detecting the posture of the front edge FA of the peeled sheet of optical functional film F1, and a pair of lamination rollers 23 and 24 for laminating the sheet of optical functional film F1 with the panel member W via the pressure-sensitive adhesive layer F2.

As shown in FIG. 4(a), the optical film laminate F is conveyed to the laminating part 20. Further, FIG. 4(a) shows a state just after a preceding sheet of optical functional film F1 is laminated with a panel member W. The optical film laminate F is conveyed with its carrier film F3 side surface being along a lower surface of the peeling means 21. The carrier film F3 is covered on the tip-end 22 of the peeling means 21 to be folded over in a direction substantially opposite to the laminating position 26, and wound by the winding means 40.

Next, as shown in FIG. 4(b), the sheet of optical functional film F1 is peeled together with the pressure-sensitive adhesive layer F2 from the carrier film F3, from the front edge FA toward the rearward, with the carrier film F3 being wound by the winding means 40. The conveyance of the sheet of optical functional film F1 and the pressure-sensitive adhesive layer F2 in a direction to the laminating position 26 is stopped by stopping driving of the winding means 40 when the sheet of optical functional film F1 and the pressure-sensitive adhesive layer F2 are peeled by a predetermined length from the front edge FA. At this moment, the front edge FA of the sheet of optical functional film F1 is at any position between the tip end 22 of the peeling means 21 to the laminating position 26, and the front edge FA is detected by the front edge detecting means 25 at this position.

In the present specification, a position on the apparatus where the pressure-sensitive adhesive layer F2 is separated from the carrier film F3 near the tip end 22 of the peeling means 21 is referred as a peeling position RP, and a length of the sheet of optical functional film F1 from the front edge FA to a position corresponding to the peeling position RP is referred as a head-out length d1. In the continuous manufacturing apparatus 1, distance from the tip end 22 of the peeling means 21 to the laminating position 26 is often designed to be generally about 20 mm to about 50 mm so that any hanging of the peeled sheet of optical functional film F1 may not be generated. Therefore, the head-out length d1 of the sheet of optical functional film F1 for detecting the front edge FA is set shorter than 50 mm, and it is preferable to set the length shorter than 20 mm.

After the front edge FA is detected by the front edge detecting means 25, driving of the winding means 40 is restarted. When the carrier film F3 is started to be conveyed again along with the restart of the driving of the winding means 40, rest part of the sheet of optical functional film F1 which has been headed out is peeled together with the pressure-sensitive adhesive layer F2 from the carrier film F3. As shown in FIG. 4(c), before/after when the front edge FA of the sheet of optical functional film F1 reached the laminating position 26, the panel member W is conveyed such that a position on the panel member W where the front edge FA of the sheet of optical functional film F1 is laminated comes to the laminating position 26. The panel member W is aligned depending on the deviation condition of the sheet of optical functional film F1 by the time it is conveyed to the laminating position 26.

With the front edge FA of the sheet of optical functional film F1 (more specifically, a front edge of the pressure-sensitive adhesive layer F2 corresponding to the front edge FA) being contacted with the panel member W by the face to be laminated, the sheet of optical functional film F1 and the panel member W are pressed by the lamination rollers 23 and 24, and the sheet of optical functional film F1 and the panel member W are laminated along with rotations of the lamination rollers 23 and 24 (FIG. 4(d)).

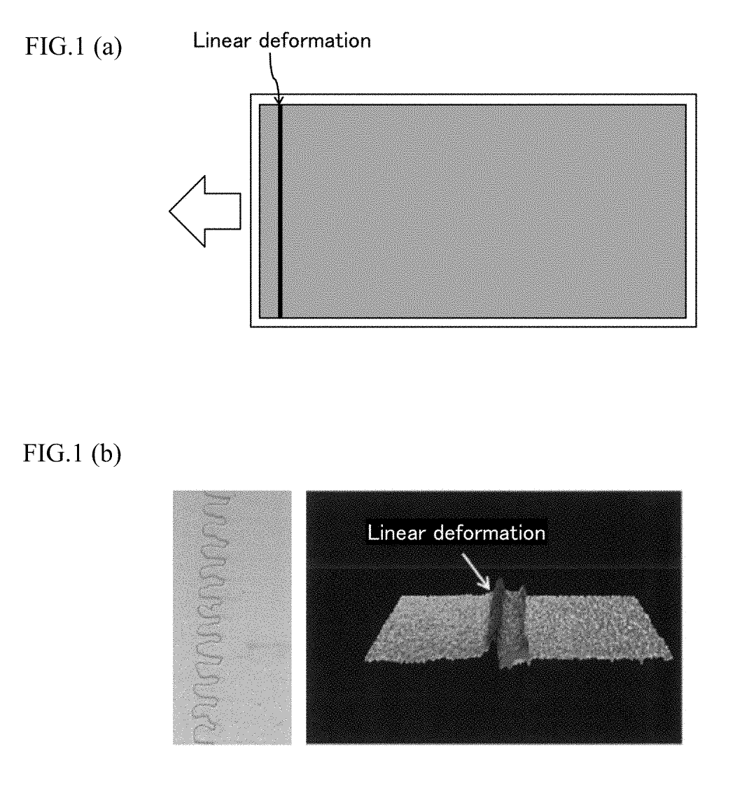

When the conveyance is stopped with the sheet of optical functional film F1 being headed out by the head-out length d1, and the detection of the front edge FA is being performed (FIG. 4(b)), a deformation D is generated on a surface of the carrier film side of the pressure-sensitive adhesive layer F2 at the position RP where the pressure-sensitive adhesive layer F2 and the carrier film F3 are separated. The deformation D is, as shown in FIG. 1(a) and FIG. 1(b), a linear deformation formed as extending in a width-wise direction of the sheet of optical functional film F1. If the sheet of optical functional film F1 with the pressure-sensitive adhesive layer F2 having such linear deformation D generated thereon is laminated with the panel member W, a deformation of the sheet of optical functional film F1 due to the deformed pressure-sensitive adhesive, and/or entrapment of bubbles between the panel member W and the pressure sensitive adhesive layer F2 may be generated, and such abnormal condition may be a cause of defect or defects of an image display device. According to the inventors' consideration, the linear deformation D which is generated on the pressure-sensitive adhesive layer F2 is generated when the conveyance of the sheet of optical functional film F1 is stopped at the time of detecting the front edge FA, and they found out a trend that the longer the time being stopped (referred as waiting time in the present specification), the higher a deformation height becomes.

In the present invention, the above problem can be solved in laminating the sheet of optical functional film F1 with the panel member W by correcting the deformation D of the pressure-sensitive adhesive layer which is generated during the waiting time for detecting the front edge FA. Specifically, in the present invention, the deformation D of the pressure-sensitive adhesive layer can be corrected by laminating a part from the front edge FA of the sheet of optical functional film F1 to at least a predetermined position FC (refer to FIG. 4(d)) with the panel member W at a first lamination speed v1 being as the maximum speed, and laminating at least a part from the predetermined position FC to a rear edge FB of the sheet of optical functional film F1 at a second lamination speed v2 which is faster than the first lamination speed v1.

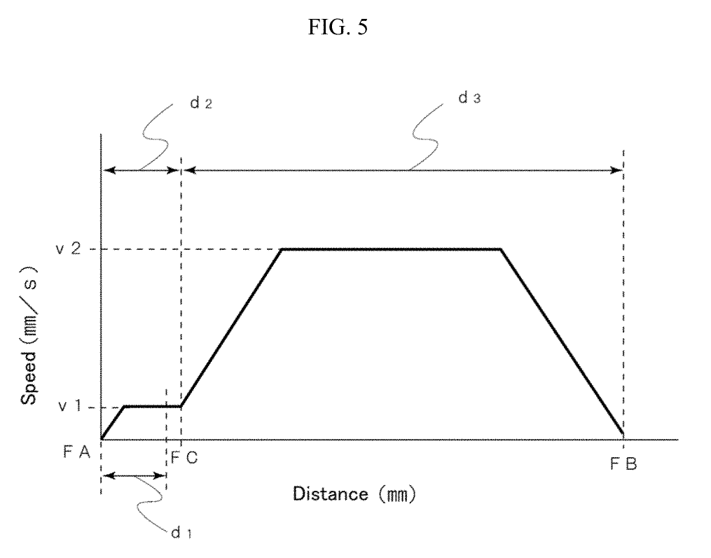

FIG. 5 is a diagram showing a change of speed in laminating a sheet of optical functional film F1 with a panel member W. A horizontal axis of FIG. 5 shows a length from a front edge FA to a rear edge FB of the sheet of optical functional film F1, and a vertical axis shows lamination speed. As shown in FIG. 5, lamination of the sheet of optical functional film F1 and the panel member W is started with the lamination speed gradually being increased, and until when a part from the front edge FA to the predetermined position FC, that is, a length d2 part is laminated, the lamination of the sheet of optical functional film F1 with the panel member W is performed at the first lamination speed v1 being as the maximum speed. As a result of the lamination performed at the first lamination speed v1, the deformation D of the pressure-sensitive adhesive layer F2 is appropriately corrected by the time shown in the state of FIG. 4(d).

The length d2 from the front edge FA to the predetermined position FC is set to be longer than the head-out length d1 of the sheet of optical functional film F1 at the time of detecting the front edge FA. That is, the predetermined position FC on the sheet of optical functional film F1 is a position upstream (at a rear edge FB side) of the head-out length d1 of the sheet of optical functional film F1 in the conveying direction. It is preferable that the predetermined position FC is at a position spaced for at least 50 mm from the front edge FA of the sheet of optical functional film F1, considering each of diameters of the lamination rollers 23 and 24, and size of the face to be laminated which is formed by deformation of the lamination rollers 23 and 24 at the time of lamination. On the other hand, it is sufficient if the predetermined position FC is at a position spaced for at most 200 mm from the front edge FA of the sheet of optical functional film F1, even when the head-out length d1 of the sheet of optical functional film F1 is long.

It is considered that the deformation D of the pressure-sensitive adhesive is appropriately corrected by being pressed with a pressing force in laminating the sheet of optical functional film F1 with the panel member W using the lamination rollers 23 and 24. Therefore, from a standpoint of correcting the deformation of the pressure-sensitive adhesive, the slower first lamination speed v1 is preferable so that the pressing force may be applied for a long time on the deformed part, but if it is too slow, time required for lamination becomes long, and production volume of the optical display device per unit time becomes less. In the present invention, it is preferable that the first lamination speed v1 is 2 mm/second to 100 mm/second such that the deformation D may be corrected to an extent that it may not be recognized as defect/defects on an image displayed in the optical display device in an inspection of a post-process. If the first speed v1 is set faster than 100 mm/second, the pressing force by the lamination rollers 23, 24 may be released from the deformed part before the deformation D of the pressure-sensitive adhesive layer is appropriately corrected. However, depending on a thickness of the optical functional film F1, since there may be a case where no defect is recognized on the image even when lamination is performed at a speed faster than 100 mm/second, it is preferable that the first speed v1 is determined based on a relationship with the thickness of the film F1.

As shown in FIG. 5, the lamination speed is further increased after the predetermined position FC is passed, and the rest part of the sheet of optical functional film, that is, a length d3 from the predetermined position FC to the rear edge FB is sequentially laminated with the panel member W. It is preferable that the second lamination speed v2 which is a speed for laminating the rest part is greater than the first lamination speed v1, and when lamination accuracy and time required for lamination is considered, 500 mm/second to 800 mm/second is preferable. There is no problem in laminating the rest part even if the second lamination speed is the same as the first lamination speed, but since time for lamination becomes longer, the production volume per unit time is sacrificed. Therefore, in laminating the length d3, it is preferable that, for at least a part of the length d3, the sheet of functional film F1 and the panel member W are laminated at the second lamination speed v2, and it is preferable that the length laminated at the second lamination speed v2 is as long as possible so that the time for lamination becomes as short as possible.

### Example

Examples and Comparative Examples of the present invention are described in the followings.

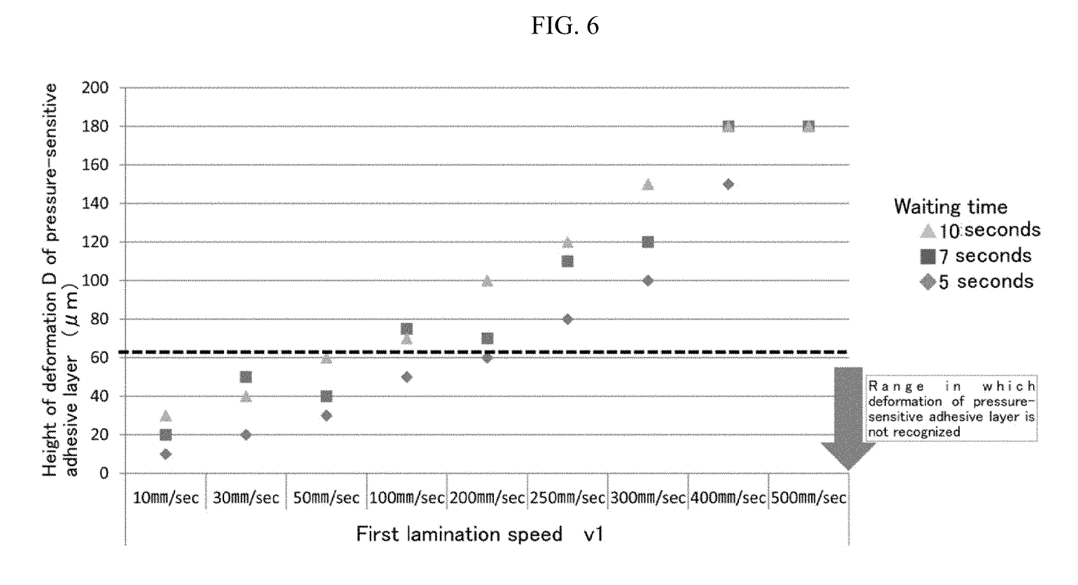

FIG. 6 is a diagram showing a relationship of a speed in laminating a sheet of optical functional film F1 with a panel member W, and a height of linear deformation D after lamination, and shows a height of the linear deformation, generated on the pressure-sensitive adhesive layer F2, after lamination, for the film which total thickness of the optical functional film F1 and the pressure-sensitive adhesive layer F2 is 135 μm. The horizontal axis is the first lamination speed v1 in laminating from the front edge FA of the optical functional film F1 to the predetermined position FC on upstream side of the head-out length d1, and the vertical axis is the height of the deformation D measured after lamination. The waiting time is a time from when the conveyance of the carrier film F3 is stopped for detecting the front edge FA of the optical functional film F1 to when the conveyance of the carrier film F3 is restarted after detection. The head-out length d1 is set as 20 mm, and the predetermined position FC is set as a position spaced for 50 mm from the front edge FA.

It is found from FIG. 6 that a deformation height of the pressure-sensitive adhesive layer F2 can be smaller as the first lamination speed v1 becomes slower, and when considered with the same lamination speed, the deformation height can be smaller as the waiting time becomes shorter. According to experiments by the inventors of the present invention, when the height of the deformation D of the pressure-sensitive adhesive layer is smaller than about 60 μm, the deformation is not recognized as defect or defects on the image displayed in the optical display device in an inspection, and thus, if the waiting time for detecting the front edge FA is equal to or less than 5 seconds, it is possible to laminate the optical functional film F1 with the panel member W at the first lamination speed v1 being as 100 mm/second. If the first lamination speed v1 is decreased to 10 mm/second, it is possible to correct the deformation D of the pressure-sensitive adhesive layer F2 to the extent that it may not be recognized as defect or defects on the image even in the case where the waiting time is 10 seconds.

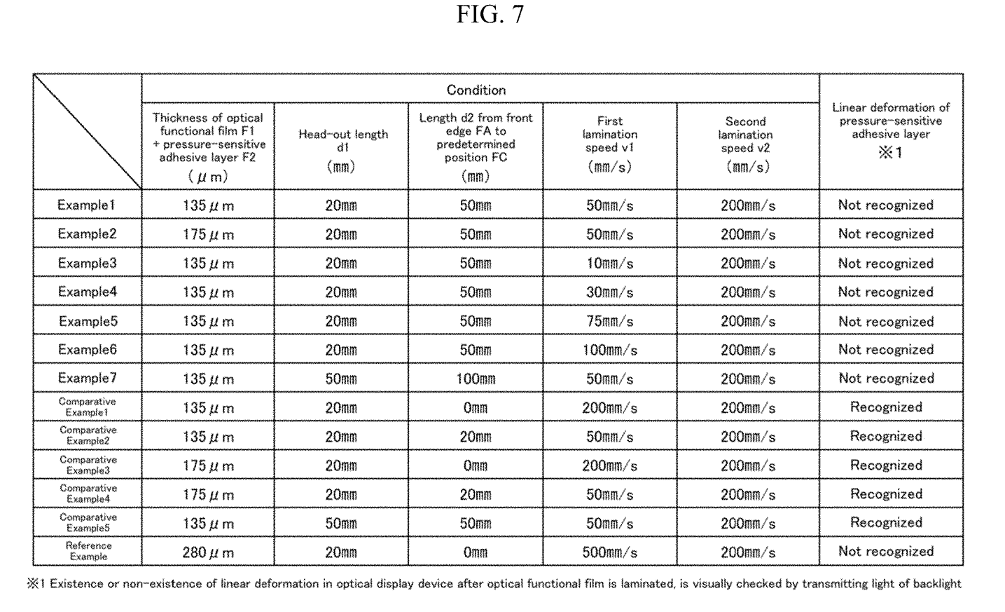

FIG. 7 is a table showing Examples and Comparative Examples of the present invention, and it shows results of inspections as to whether the linear deformation D is visually recognized after laminating the optical functional film F1 with the panel member W via the pressure-sensitive adhesive layer F2, when the total thickness of the optical functional film F1 and the pressure-sensitive adhesive layer F2, the head-out length d1 at the time of detecting the front edge FA, and lamination conditions are changed. The inspections are performed for the optical display device produced by laminating the optical functional film F1 with the panel member W via the pressure-sensitive adhesive layer F2 by checking as to whether the linear deformation is visually recognized when a light of backlight is transmitted.

Examples 1, 3 to 7 are inspection results of when a film (F1+F2) consisting of the optical functional film F1 and the pressure-sensitive adhesive layer F2 having a total thickness of 135 μm is laminated with the panel member W, and Example 2 is an inspection result when a film (F1+F2) having a thickness of 175 μm is laminated with the panel member W, and no linear deformation D of the pressure-sensitive adhesive layer was visually recognized in any of them.

Comparative Examples 1, 2 and 5 are results when the film (F1+F2) having the same thickness as that of Examples 1, 3 and 7 is used, and Comparative Examples 3 and 4 are results when the film (F1+F2) having the same thickness as that of Example 2 is used. As shown in Comparative Examples 1 and 3, when the lamination from the front edge FA to the rear edge FB is performed at an identical fast speed (200 mm/second), the linear deformation D of the pressure-sensitive layer F2 was recognized. In addition, as shown in Comparative Examples 2, 4 and 5, when the length d2 from the front edge FA to the predetermined position FC is the same as the head-out length d1 (20 mm or 50 mm), the linear deformation D of the pressure-sensitive layer F2 was recognized even if the lamination up to the predetermined position FC was performed at low speed (50 mm/second).

Further, Reference Example is a result when a visual inspection similar to that of Comparative Example is performed using a film (F1+F2) having a thickness of 280 μm. With a film having such level of thickness, it is found as that the linear deformation D is not recognized even if the lamination is performed at a fast speed from the front edge FA.

### REFERENCE SIGNS LIST

1: continuous manufacturing apparatus
11: roll of optical film laminate F′
13, 17: feed rollers
14, 18: dancing rollers
15: slitting part
20: laminating part
21: peeling means
22: tip-end of peeling means
23, 24: lamination rollers
25: front edge detecting means
26: laminating position
30: conveying means
32: aligning part
33: panel position detecting means
40: winding means
41: feed roller
50: controller
51: controlling means
52: storing means
F′, F: optical film laminate
F1′: band of optical functional film
F1: sheet of optical functional film
F2: pressure-sensitive adhesive layer
F3: carrier film
FA: front edge of sheet of optical functional film
FB: rear edge of sheet of optical functional film
FC: predetermined position on sheet of optical functional film
W: panel member
P: panel laminate
D: linear deformation of pressure-sensitive adhesive layer
d1: head-out length of sheet of optical functional film
d2: length of sheet of optical functional film to be laminated at first lamination speed (length from
FA to FC)
d3: length of rest part of sheet of optical functional film (length from FC to FB)
v1: first lamination speed
v2: second lamination speed

1. A method for manufacturing an optical display device from a band of optical film laminate including a carrier film, a pressure-sensitive adhesive layer formed on one of opposite surfaces of the carrier film and a plurality of sheets of optical functional film continuously supported on the carrier film via the pressure-sensitive adhesive layers by peeling the sheet of optical functional film together with the pressure-sensitive adhesive layer from the carrier film of the band of optical film laminate, and laminating the peeled sheet of optical functional film with a corresponding one of panel members at a laminating position, the method comprising steps of:
peeling the sheet of optical functional film together with the pressure-sensitive adhesive layer from the carrier film by conveying the carrier film, with the carrier film being folded over at a tip end of a peeling body arranged at a position facing the laminating position,
when the sheet of optical functional film is peeled by a predetermined head-out length from a front edge, stopping the conveyance of the carrier film for detecting the front edge,
conveying the carrier film for making the front edge of the sheet of optical functional film proceed to the laminating position,
laminating from the front edge to a predetermined position upstream of the head-out length on the sheet of optical functional film with the panel member at a first lamination speed being as the maximum speed,
laminating at least a part from the predetermined position to a rear edge of the sheet of optical functional film with the panel member at a second lamination speed faster than the first lamination speed.

2. The method according to claim 1, wherein the predetermined position is a position spaced for 50 mm to 200 mm from the front edge of the sheet of optical functional film.

3. The method according to claim 1, wherein the first lamination speed is 2 mm/second to 100 mm/second.

4. The method according to claim 1, wherein waiting time from when the conveyance of the carrier film for detecting the front edge is stopped to when the conveyance of the carrier film is restarted after detection is 3 seconds to 5 seconds.
